(19) United States
(12) Patent Application Publication
(10) Pub. No.: US 2014/0040093 A1
(43) Pub. Date: Feb. 6, 2014

(54) METHOD AND SYSTEM FOR ELECTRONIC TRADING OF FINANCIAL INSTRUMENTS

(71) Applicant: BLACKROCK, INC., New York, NY (US)

(72) Inventors: Joseph M. Kochansky, New York, NY (US); Richard Schiffman, New York, NY (US); Sarah Schaffer, New York, NY (US)

(21) Appl. No.: 13/888,115

(22) Filed: May 6, 2013

Related U.S. Application Data
(60) Provisional application No. 61/643,029, filed on May 4, 2012.

(51) Int. Cl. G06Q 40/04

(52) U.S. Cl. CPC G06Q 40/04
USPC 705/37

(57) ABSTRACT

A method and system for providing computer-implemented trading of securities. Respective computer-generated interfaces are provided from a counter-party system between a plurality of dealers and a plurality of clients. A network enables messages to be directly exchanged between the dealer interfaces and the client interfaces. Enabling at least a particular client to submit an inquiry, via the respective client interface, for trading a particular security to at least one of the plurality of the dealers. Enabling the dealers to provide respective offers and/or bids, via their respective dealer interfaces, in response to a client inquiry submitted thereto. Communicating, via the computer generated interfaces, the offers and/or bids directly to the particular client from a particular dealer for consideration thereby.

### CROSS REFERENCE TO RELATED APPLICATIONS

This application claims priority to U.S. Patent Application Ser. No. 61/643,029 filed May 4, 2012 which is incorporated herein by reference in its entirety.

### FIELD OF THE INVENTION

The invention generally relates to a system and method for electronic trading and, in particular, to a system and method for the creation, communication, and execution of trades for financial instruments including securities,

### BACKGROUND OF THE INVENTION

The buying and selling of financial instruments is well known. For instance, and with regards to debt securities, bond trading has typically been conducted using various methods. Once such method involves auctions whereby dealers and investors communicate with one another to offer and accept various prices and terms for different bonds. Multiple investors, typically institutional investors, can select a bid from competing dealers. It is to be appreciated this process suffers obvious disadvantages in that the number of investors and dealers that can be involved is limited. Yet another method for bond trading involves the use of cross-matching systems wherein anonymous buy and sell offers that are entered are matched by a broker. However, this method and system has the disadvantage that the investors and dealers cannot choose to deal with a specific known party. For example, an investor may prefer to buy from a specific selling entity (e.g., a broker, dealer or individual) who has successfully filled orders in the past, or where some other pre-established relationship has been developed. Similarly, a selling entity may prefer to sell to specific investors.

Still another method for bond trading involves multiple single-dealer systems, whereby an investor executes an order with a specific dealer or dealers. A noted drawback of this method is the requirement that the investor contact each dealer to determine what inventory and terms are being offered. Additionally, the terms that are offered can change from minute to minute, and the latest information may not be offered to all investors on an equal basis.

It is also noted that various computer-based systems have been developed for the buying and selling of equity securities, such as stocks. Many of these systems are targeted to the individual investor who accesses the system via an Internet web browser. Other systems, which are used by investment houses and serious individual investors such as day traders, use private networks to communicate with market makers, who are typically located at the trading floors of the major stock exchanges. Moreover, some private networks allow trading for individual dealers. However, none of these systems provide a system and method for trading debt securities.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages, and in accordance with the purpose of the illustrated embodiments, in one aspect, a method and system is described for providing computer-implemented trading of securities wherein respective computer-generated interfaces are provided from a counter-party system between a plurality of dealers and a plurality of clients. A network enables messages to be directly exchanged between the dealer interfaces and the client interfaces. Enabling at least a particular client to submit an inquiry, via the respective client interface, for trading a particular security to at least one of the plurality of the dealers. Enabling the dealers to provide respective offers and/or bids, via their respective dealer interfaces, in response to a client inquiry submitted thereto. Communicating, via the computer generated interfaces, the offers and/or bids directly to the particular client from a particular dealer for consideration thereby.

### BRIEF DESCRIPTION OF THE DRAWINGS

The accompanying appendices and/or drawings illustrate various non-limiting, example, inventive aspects in accordance with the present disclosure:

FIG. 1 illustrates a schematic diagram depicting the core functional components of a computer-based system for implementing a system and method in accordance with the illustrated embodiments;

FIG. 2 illustrates a diagram depicting security trading between a client and dealers, with dealer response timing, in accordance with an illustrated embodiment; and

FIG. 3 depicts a flow diagram for security trading in accordance with an illustrated embodiment.

### DETAILED DESCRIPTION OF CERTAIN EMBODIMENTS

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be understood the present invention described herein is related to U.S. Pat. No. 7,430,532, the contents of which are hereby incorporated by reference in its entity. It is to be further understood and appreciated that the invention described herein is to be applicable to all forms and types of financial instruments, and only for illustrative and ease of description purposes are the below illustrative embodiments set forth in Appendix A provided with reference to debt securities (such as bonds). Thus, the invention is to be understood to encompass other types of securities such as equity (e.g., common stock), derivative contracts (e.g., forwards, futures, options and swaps) as well as any other like financial instrument capable of being traded for value.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

It is to be appreciated the embodiments of this invention as discussed below are preferably a software algorithm, program or code residing on computer useable medium having control logic for enabling execution on a machine having a computer processor.

The machine typically includes memory storage configured to provide output from execution of the computer algorithm or program.

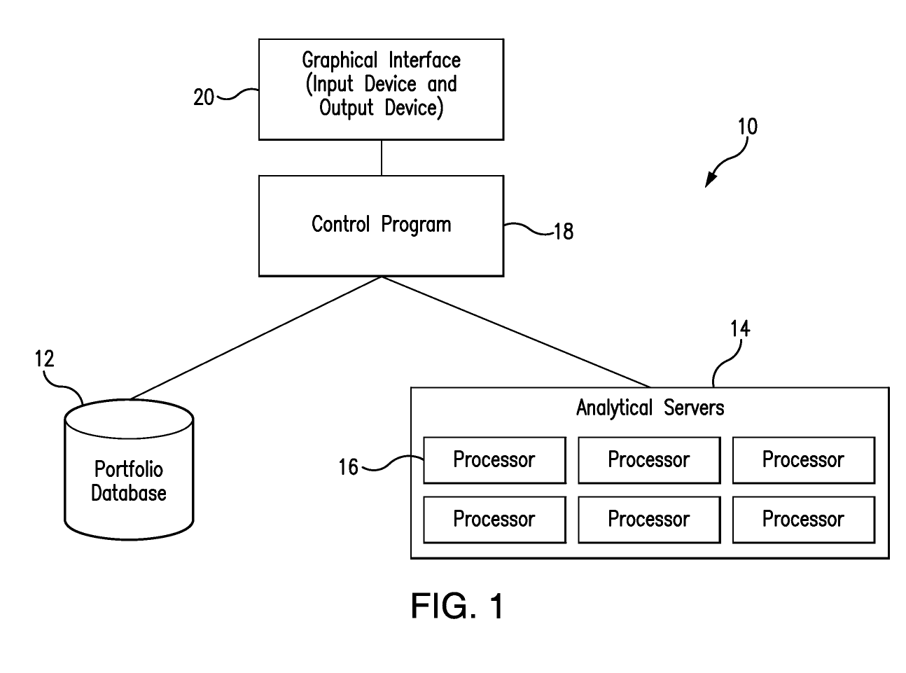

Turning now descriptively to the drawings, in which similar reference characters denote similar elements throughout the several views, FIG. 1 depicts an exemplary general-purpose computing system in which illustrated embodiments of the present invention may be implemented.

Referring now to the drawings wherein there is a schematic representation illustrated in FIG. 1 of the core functional components of the computer-based trading system of the generally by reference numeral and described in U.S. Pat. No. 7,430,532 (incorporated herein) to which illustrated embodiments of the present invention may be implemented therewith. The trading system 10 in one embodiment, is adapted and configured to facilitate interaction between an analytics platform and a trading platform. In particular, the system 10 facilitates a trade of a previously analyzed fixed income security with a single, user-controlled action, More particularly, system 10 enables a user, through a graphical user interface, to selectively analyze a fixed income security under hypothetical market conditions (e.g., typically to model its future performance and effect on a portfolio of fixed income securities as if it were traded for and added thereto) and enter a trade for that fixed income security to one or more portfolios via a single on-screen actuator, through keyboard or a computer peripheral device such as a mouse. System 10 is intended for use by, among others, portfolio managers, agents, custodians and investors involved in the buying and selling of fixed income securities.

Preferably, the graphical user interfaces (also referred to as “screens”) used by system 10 incorporates user-friendly features and fit seamlessly with other operating system interfaces, that is, in a framed form having borders, multiple folders, toolbars with pull-down menus, embedded links to other screens and various other selectable features associated with animated graphical representations of depressible buttons. These features can be selected (i.e., “clicked on”) by the user via connected mouse, keyboard, voice command or other commonly used tool for indicating a preference in a computerized graphical interface.

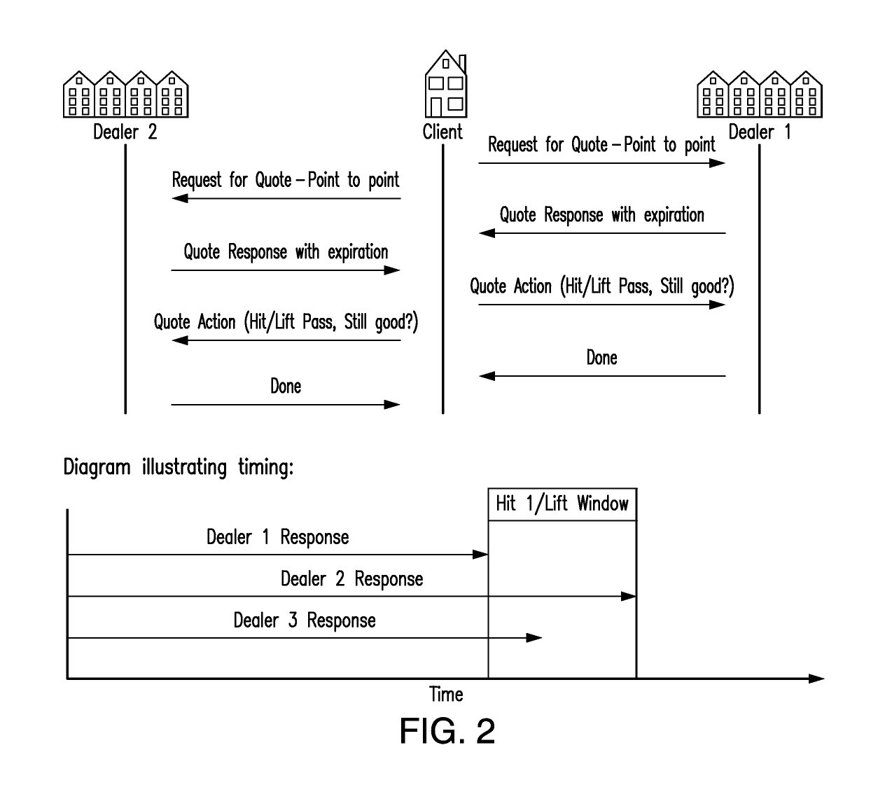

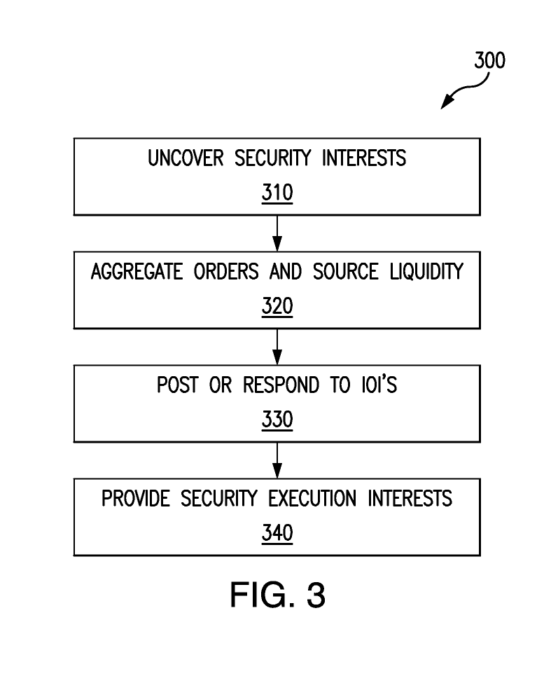

FIGS. 2 and 3, which are discussed in detail below, illustrate the exemplary embodiments, including graphical user interfaces for use with the trading system and method of the subject disclosure for use with system 10 of FIG. 1.

Referring to FIG. 1, trade entry system 10 is associated with a data storage device or memory 12 and an analytical server 14 having a processor 16 which is operatively associated with the memory 12 via control program 18 for managing the flow of data throughput. Alternatively, and as shown in the embodiment of the present disclosure depicted in FIG. 1, a plurality of analytical servers 14 and processors 16 can be associated with memory 12 and control program 18. Data input and output devices, collectively referred to as graphical interface 20, are operatively associated with the memory 12 and processors 16 for receiving data and instructions and reporting information through control program 18.

Memory 12 further contains a portfolio database storing a plurality of investment portfolios owned by individual or institutional investors. Each portfolio includes a plurality of investment products in the form of fixed income securities such as U.S. Treasury notes or bonds, municipal, corporate or agency bonds, mortgage backed securities or derivative instruments. Program 18 contains an instruction set written in a conventional computing language such as HTML, C++ or Java (which the illustrated embodiments are not to be limited thereto), for coordinating the interactive relationship between memory 12, processors 16, and graphical interface 20.

Program 18 and processors 16 enable system 10 to provide inter-day and intra-day computations and real-time market data useful for conducting various types of analyses involving fixed income securities and the portfolios in the portfolio database stored in memory 12, per instructions received from graphical interface 20. Preferably, system 10 is operatively associated with the world wide web and configured such that graphical interface 20 may send and receive data over the world wide web. System 10 preferably allows a portfolio manager to change underlying assumptions, relating to, among other things, measures useful for modeling performance of financial instruments and making risk management decisions for a portfolio of financial instruments under various economic conditions.

In the description that follows, certain embodiments may be described with reference to acts and symbolic representations of operations that are performed by one or more computing devices, such as the computing system environment 10 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

With the exemplary trading computing system environment 10 of FIG. 1 being generally shown and discussed above, illustrated embodiments of the invention are described below may use the above described system 10, or components thereof in a network environment with reference to FIGS. 2 and 3.

It is to be understood an embodiment of the present invention provides a trading system (e.g., trading platform) enabling cross-trading functionality for preferably fixed income securities directly between a client and one or more dealers, in which system 10, is preferably a counterparty between a client 200 and a plurality of dealers 210, 220 (it is noted FIG. 2 depicts first and second dealers 210, 220 for ease of illustration purposes, the present invention is not to be limited thereto as it may encompass any plurality of dealers). As soon in FIG. 2, and with system 10 acting as a counterparty to client 200 and dealers 210 and 220, client 200 sends a request for trade quote 222, 224 directly from client 210 to each of the dealers 210 and 220. Each dealer then directly responds to client with a quote response 226, 228 (preferably each having an expiration time). The client 200 may then directly respond to each dealer 210, 220 with a quote action 230, 232, after which transaction between each dealer 210, 220 and the client is completed 234, 236. It is noted the dealer response time regarding a client request for quote may vary between each dealer 250, 252 and 254.

More specifically, and with reference to process 300 of FIG. 3, system 10 is preferably configured to be operational as a centralized database for maintaining financial information including positions, transactions, prices, security data and analytics. System 10 preferably provides the functionality of uncovering two or more opposing interests in the same security or similar securities and matches participants' orders at an appropriate price by seeking dealer quotes or using other pricing means (step 310). When no matching interests are found, system 10 preferably aggregates participants' orders and sources street liquidity (step 320). Participants may post indications of interest (IOI's) and/or respond to IOI's of other participants to facilitate transactions in system 10 (step 330). System 10 also preferably provides general execution services without participants having to first participate in any matching opportunity (step 340).

System 10 is preferably configured to facilitate the trading of bonds amongst buy-side participants. System 10 is configured to provide an execution service that may utilize Electronic Communication Networks (ECN) and other Alternative Trading Systems (ATS) capabilities to enhance client trade executions and complete trades. Contrary to prior art methods and systems in which ATN pricing for matching is confirmed by a client prior to trade execution, in accordance with an illustrated embodiment of system 10, an electronic trading desk facilitates client trades, obtains favorable pricing while communicating to client, and/or dealers, pricing information for both completed and potentially non-completed trades. Preferably, price is defined between the buyer and seller and is not known until a sale is consummated. It is to be understood system 10 trades are preferably processed through a single, common counterparty as a riskless principal (e.g., BlackRock Capital Markets) permitting clients to remain anonymous to other buy-side firms, which simplifies the trade processing for a buy-side client. However, it is also understood system 10 may also act as an agent in certain circumstances (e.g., when BlackRock is a party to a transaction).

Optional embodiments of the present invention apart from what is described above may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a description of a best mode contemplated for carrying out the present invention, and of the manner and process of making and using them, in such full, clear, concise, and exact terms as to enable any person skilled in the art to which it pertains to make and use these devices and methods. The present invention is, however, susceptible to modifications and alternative method steps from those discussed above that are fully equivalent. Consequently, the present invention is not limited to the particular embodiments disclosed herein. On the contrary, the present invention encompasses all modifications and alternative constructions and methods coming within the spirit and scope of the present invention.

The descriptions above and the accompanying drawings, should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A method for providing computer-implemented trading of securities, comprising:
providing respective computer-generated interfaces from a counter-party system between a plurality of dealers and a plurality of clients wherein a network enables messages to be directly exchanged between the dealer interfaces and the client interfaces;
enabling at least a particular client to submit an inquiry, via the respective client interface, for trading a particular security to at least one of the plurality of the dealers;
enabling the dealers to provide respective offers and/or bids, via their respective dealer interfaces, in response to a client inquiry submitted thereto; and
communicating, via the computer generated interfaces, the offers and/or bids directly to the particular client from a particular dealer for consideration thereby.

2. A method as recited therein, further including facilitating security trades between the clients and dealers to obtain favorable pricing information for both completed and non-completed trades.

3. A method as recited in claim 2 wherein pricing information is defined between a buyer and seller and is not known until a sale is consummated.

4. A method as recited in claim 1 wherein security trades are processed through a common-counterparty to enable clients to remain anonymous to other buy-side participants.

5. A method as recited in claim 1 wherein said securities include bonds.

6. A method as recited in claim 5 further including enabling trading of bonds amongst buy-side participants.

7. A method as recited in claim 1 wherein the computer-implemented trading of securities includes implementation of Electronic Communication Networks.

8. A method as recited in claim 1 wherein the computer-implemented trading of securities includes implementation of Alternative Trading Systems.

9. A system for electronically trading securities, comprising:
a memory;
a processor disposed in communication with said memory, and configured to issue a plurality of instructions stored in the memory, wherein the instructions issue signals to:
provide respective computer-generated interfaces from a counter-party system between a plurality of dealers and a plurality of clients wherein a network enables messages to be directly exchanged between the dealer interfaces and the client interfaces;
enable at least a particular client to submit an inquiry, via the respective client interface, for trading a particular security to at least one of the plurality of the dealers;
enable the dealers to provide respective offers and/or bids, via their respective dealer interfaces, in response to a client inquiry submitted thereto; and
communicate, via the computer generated interfaces, the offers and/or bids directly to the particular client from a particular dealer for consideration thereby.

10. A system as recited in claim 9, wherein the processor instructions further issues signals to facilitate security trades between the clients and dealers to obtain favorable pricing information for both completed and non-completed trades.

11. A system as recited in claim 9 wherein pricing information is defined between a buyer and seller and is not known until a sale is consummated.

12. A system, as recited in claim 9 wherein security trades are processed through a common-counterparty to enable clients to remain anonymous to other buy-side participants.

13. A system as recited in claim 9 wherein said securities include bonds.

14. A system as recited in claim 13 wherein the processor instructions further issues signals to enable trading of bonds amongst buy-side participants.

15. A non-transitory computer readable storage medium and one or more computer programs embedded therein, the computer programs comprising instructions, which when executed by a computer system, cause the computer system to:
provide respective computer-generated interfaces from a counter-party system between a plurality of dealers and a plurality of clients wherein a network enables messages to be directly exchanged between the dealer interfaces and the client interfaces;
enable at least a particular client to submit an inquiry, via the respective client interface, for trading a particular security to at least one of the plurality of the dealers;
enable the dealers to provide respective offers and/or bids, via their respective dealer interfaces, in response to a client inquiry submitted thereto; and
communicate, via the computer generated interfaces, the offers and/or bids directly to the particular client from a particular dealer for consideration thereby.

16. A non-transitory computer readable storage medium as recited in claim 15, wherein the one or more computer programs further issues signals to facilitate security trades between the clients and dealers to obtain favorable pricing information for both completed and non-completed trades.

17. A non-transitory computer readable storage medium as recited in claim 16 wherein pricing information is defined between a buyer and seller and is not known until a sale is consummated.

18. A non-transitory computer readable storage medium as recited in claim 9 wherein the one or more computer programs further issues signals to cause security trades to be processed through a common-counterparty to enable clients to remain anonymous to other buy-side participants.

19. A non-transitory computer readable storage medium as recited in claim 15 wherein said securities include bonds.

20. A non-transitory computer readable storage medium as recited in claim 19 wherein the one or more computer programs further issues signals to enable trading of bonds amongst buy-side participants.
